(19) United States
(12) Patent Application Publication
(10) Pub. No.: US 2026/0164246 A1
(43) Pub. Date: Jun. 11, 2026

(54) METHOD AND DEVICE FOR MANAGING ULTRA-WIDEBAND SESSION

(71) Applicant: Samsung Electronics Co., Ltd., Suwon-si, Gyeonggi-do (KR)

(72) Inventors: Kisoo AN, Suwon-si (KR); Sehee HAN, Suwon-si (KR); Sungdong KIM, Suwon-si (KR)

(21) Appl. No.: 19/125,619

(22) PCT Filed: Nov. 6, 2023
(86) PCT No.: PCT/KR2023/017683

§ 371 Date: Apr. 29, 2025

(30) Foreign Application Priority Data
Nov. 4, 2022 (KR) 10-2022-0146443

(51) Int. Cl. H04W 12/30; H04W 4/80

(52) U.S. Cl. CPC H04W 12/30; H04W 4/80

(57) ABSTRACT

The present disclosure discloses a method for managing a UWB session. A method of an electronic device, according to one embodiment of the present disclosure, may comprise the steps of: identifying setting information for a service of a UWB support application; generating service instance ID information for the service on the basis of the setting information; establishing a secure channel between a software-based security component within a framework of the electronic device and a software-based security component within a framework of another electronic device; and exchanging data for establishing a UWB session through the secure channel between secure components.

### CROSS-REFERENCE TO RELATED APPLICATION(S)

This application is a U.S. National Stage application under 35 U.S.C. § 371 of an International application number PCT/KR2023/017683, filed on Nov. 6, 2023, which is based on and claims priority of a Korean patent application number 10-2022-0146443, filed on Nov. 4, 2022, in the Korean Intellectual Property Office, the disclosure of which is incorporated by reference herein in its entirety.

### TECHNICAL FIELD

The disclosure relates to UWB communication and, more specifically, to a method and device for managing a UWB session.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of conventional information technology (IT) techniques and various industries.

As wireless communication systems evolve to provide various services, a need arises for a method for effectively providing such services. For example, it is possible to use a ranging technique for measuring the distance between electronic devices using ultra-wide band (UWB).

### DETAILED DESCRIPTION OF THE INVENTION

### Technical Problem

The disclosure provides a method for managing a UWB session using a software-based secure component in a framework.

### Technical Solution

According to an embodiment of the disclosure, a method by an electronic device performing UWB communication may comprise identifying configuration information for a service of a UWB-enabled application, generating service instance ID information about the service based on the configuration information, establishing a secure channel between a software-based secure component in a framework of the electronic device and a software-based secure component in a framework of another electronic device, and exchanging data for establishing a UWB session between the secure components through the secure channel. The configuration information may include at least one of service configuration information, UWB configuration information, or OOB configuration information.

According to another embodiment of the disclosure, an electronic device performing UWB communication may comprise memory and a processor connected to the memory. The processor may be configured to: identify configuration information for a service of a UWB-enabled application, generate service instance ID information about the service based on the configuration information, establish a secure channel between a software-based secure component in a framework of the electronic device and a software-based secure component in a framework of another electronic device, and exchange data for establishing a UWB session between the secure components through the secure channel. The configuration information may include at least one of service configuration information, UWB configuration information, or OOB configuration information.

### Advantageous Effects

The method and device according to an embodiment of the disclosure may efficiently manage a UWB session using a software-based secure component in a framework.

### BRIEF DESCRIPTION OF THE DRAWINGS

FIG. 1 is a block diagram schematically illustrating an electronic device;

FIG. 2A illustrates an example architecture of a UWB device according to an embodiment of the disclosure;

FIG. 2B illustrates an example configuration of a framework of a UWB device according to an embodiment of the disclosure;

FIG. 3 is a view illustrating operations of an electronic device for issuing an UWB according to an embodiment of the disclosure;

FIG. 4 illustrates a method for exchanging data between UWB devices including a secure element according to an embodiment of the disclosure;

FIG. 5 illustrates a method for establishing a secure channel between UWB devices according to an embodiment of the disclosure;

FIG. 6 illustrates an example of an application data structure according to an embodiment of the disclosure;

FIG. 7 illustrates a method for a UWB device to manage data using a secure element according to an embodiment of the disclosure;

FIG. 8 illustrates a method for a UWB device to manage data using a secure component in a framework according to an embodiment of the disclosure;

FIG. 9 illustrates a configuration of a software-based secure component according to an embodiment of the disclosure;

FIG. 10 illustrates a method for generating a service instance ID according to an embodiment of the disclosure;

FIG. 11 illustrates a method for a UWB device to manage a UWB session according to an embodiment of the disclosure; and

FIG. 12 illustrates a configuration of a UWB device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflect the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in a computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless communication capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. Further, although a communication system using UWB is described in connection with embodiments of the present invention, as an example, embodiments of the present invention may also apply to other communication systems with similar technical background or features. For example, a communication system using Bluetooth or ZigBee may be included therein. Further, embodiments of the present invention may be modified in such a range as not to significantly depart from the scope of the present invention under the determination by one of ordinary skill in the art and such modifications may be applicable to other communication systems.

When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

The terminology used herein is provided for a better understanding of the disclosure, and changes may be made thereto without departing from the technical spirit of the disclosure.

“Application protocol data unit (APDU)” may be a command and a response used when communicating with the application data structure in the UWB device (e.g., FiRa device). Command APDU is an APDU including a command, and response APDU is an APDU including a response.

“Application data structure” may be a file system having a route level and an application level including a data object such as a UWB controlee info data object and a UWB session data data object required for establishing a UWB session. The data object may be BER-TLV encoded information including a tag field, a length field, and/or a value field.

“Application dedicated file (ADF)” may be, e.g., a data structure in an application data structure that may host an application or application specific data.

“Object Identifier (OID)” may be an identifier of the ADF in the application data structure.

“Global Dedicated File (GDF)” may be a root level of application specific data including data required to establish a UWB session.

“Provisioning authority (PA)” may be a third-party entity that has the rights to manage the application data structure of the UWB device. The service provider may use the PA to write its ADF in the application data structure and provision or delete the service.

“Controller” may be a ranging device that defines and controls ranging control messages (RCM) (or control messages). The controller may define and control ranging features by transmitting a control message.

“Controlee” may be a ranging device using a ranging parameter in the RCM (or control message) received from the controller. The controlee may use the same ranging features as those configured through control messages from the controller.

“Initiator” may be a Ranging Device that initiates a ranging exchange. The initiator may initiate a ranging exchange by transmitting a first RFRAME (ranging exchange message).

“Responder” may be a ranging device that responds to the Initiator in a ranging exchange. The responder may respond to the ranging exchange message received from the initiator.

“STS” may be a ciphered sequence for increasing the integrity and accuracy of ranging measurement timestamps.

“Static STS mode” is an operation mode in which STS is repeated during a ranging session, and does not need to be managed by the Secure Component.

Unlike “static STS,” “dynamic scrambled timestamp sequence (STS) mode” may be an operation mode in which the STS is not repeated during a ranging session. In this mode, the STS may be managed by the secure component in this mode.

“UWB Applet” may be an applet including service data and UWB parameters that may be provisioned by, e.g., the service provider. The UWB Applet may be a FiRa defined Applet (FiRa Applet) executed on the Secure Component. Service data is data defined by the service provider and may be data that needs to be transferred between two UWB devices for service implementation. The service provider may be an entity that defines and provides hardware and software required to provide a specific service to an end-user.

“Service Applet” may be an applet that handles service-specific transactions (e.g., providing credentials to unlock a door). The Service Applet may be an applet on a Secure element.

“SUS Applet” may be a Secure element that communicates with a UWB Applet or Service Applet to retrieve data/information to enable a secure UWB session with another UWB device, and transfers the data/information to the UWBS. The SUS Internal API may be an interface exposed by the SUS Applet, as the Service Applet or UWB Applet capable of generating an RDS, to transfer the RDS to the SUS Applet. The SUS External API may be an interface exposed to the UWBS by the SUS Applet that enables the UWBS to search for the RDS.

“Key Exchange Applet” may be an applet that creates an RDS and provides the RDS to UWBS via the SUS Applet.

“Ranging device” may be a device capable of performing UWB ranging. In the disclosure, the ranging device may be an enhanced ranging device (ERDEV) defined in IEEE 802.15.4z or a FiRa Device. The ranging device may be referred to as a UWB device.

“UWB-enabled Application” may be an application for UWB service. For example, the UWB-enabled Application may be an application using a Framework API for configuring an OOB Connector component, a Secure Service component, and/or a UWB service component for a UWB session. “UWB-enabled Application” may be abbreviated as an application or a UWB application. UWB-enabled Application may be a FiRa-enabled Application. “Framework API” may be an API used by a UWB-enabled Application to communicate with the Framework.

“Framework” may be a component that provides access to Profiles, individual-UWB configuration and/or notifications. “Framework” may be, e.g., a collection of logical software components including the Profile Manager component, OOB Connector component, Secure Service component, UWB Service component, and/or OOB Service component. The framework may be a FiRa framework.

“OOB Connector” may be a software component for establishing an out-of-band (OOB) connection (e.g., BLE connection) between Ranging Devices. The OOB connector may be a FiRa OOB connector.

“Profile” may be a previously defined set of UWB and OOB configuration parameters. The Profile may be a FiRa Profile or a Custom Profile.

“Profile Manager” may be a software component that implements a profile available on the Ranging Device. The profile manager may be a FiRa profile manager.

“Out-Of-Band (OOB)” may be data communication that does not use UWB as an underlying wireless technology.

“OOB Subsystem” may be a hardware component responsible for establishing an OOB connection between UWB devices.

“Ranging Data Set (RDS)” may be data (e.g., UWB session key, session ID, etc.) required to establish a UWB session when it is needed to protect confidentiality, authenticity and integrity.

“Secure channel” may be a data channel that prevents overhearing and tampering.

“Secure Component” may be an entity (e.g., Secure Element (SE) or Trusted Execution Environment (TEE)) with a defined security level that interfaces with the UWBS.

“SE” may be a tamper-resistant secure hardware component that may be used as a Secure Component in the Ranging Device. The SE may be, e.g., embedded SE (eSE).

“Secure ranging” may be ranging based on STS generated through a strong encryption operation.

“Secure Service” may be a software component for interfacing with the Secure Component.

“Secure Messaging” may be the exchange of structured data carried over a secure channel.

“Secure Messaging Authentication Key” may be a key used to establish a secure channel to perform Secure Messaging.

“Secure Messaging Session Keys” may be keys used after a secure channel is established to ensure Secure Messaging.

“Privacy Selection Key” may be a key used to protect privacy during authentication.

“UWB Service” may be a software component that provides access to the UWBS.

“UWB Session” may be a period from when the Controller and the Controlee start communication through UWB until the communication stops. A UWB Session may include ranging, data transfer, or both ranging and data transfer.

“UWB Session ID” may be an ID (e.g., a 32-bit integer) that identifies the UWB Session, shared between the controller and the controller.

“UWB session key” may be a key used to protect the UWB Session. The UWB Session Key may be used to generate the STS. The UWB session key may be a UWB ranging session key (URSK), and may be abbreviated as a session key.

“UWB Subsystem (UWBS)” may be a hardware component implementing the UWB PHY and MAC layers specifications. UWBS may have an interface to Framework and an interface to Secure Component to search for RDS.

“UWB message” may be a message including a payload IE transmitted by the UWB device (e.g., ERDEV). The UWB message may be such a message as, e.g., ranging initiation message (RIM), ranging response message (RRM), ranging final message (RFM), control message (CM), measurement report message (MRM), ranging result report message (RRRM), control update message (CUM) or one-way ranging (OWR) message. If necessary, a plurality of messages may be merged into one message.

“OWR” may be a ranging scheme using messages unilaterally transmitted between a ranging device and one or more other ranging devices. OWR may be used to measure Time Difference of Arrival (TDoA) (e.g., downlink (DL)-TDoA or uplink (UL)-TDoA). Additionally, OWR may be used to measure AoA at the receiving end, rather than measuring TDoA. In this case, a pair of advertiser and observer may be used.

“TWR” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. For example, SS-TWR may include a RIM transmission operation from the initiator to the responder, and an RRM transmission operation from the responder to the initiator. DS-TWR may be a procedure for performing ranging through two round-trip time measurements. For example, DS-TWR may include a RIM transmission operation from the initiator to the responder, an RRM transmission operation from the responder to the initiator, and an RFM transmission operation from the initiator to the responder. Through the ranging exchange, the time of flight (ToF) may be calculated, and the distance between the two devices may be estimated. Meanwhile, during the TWR process, the measured AoA information (e.g., AoA azimuth result, AoA elevation result) may be transferred to another ranging device through RRRM or other messages. In the disclosure, TWR may also be referred to as UWB TWR.

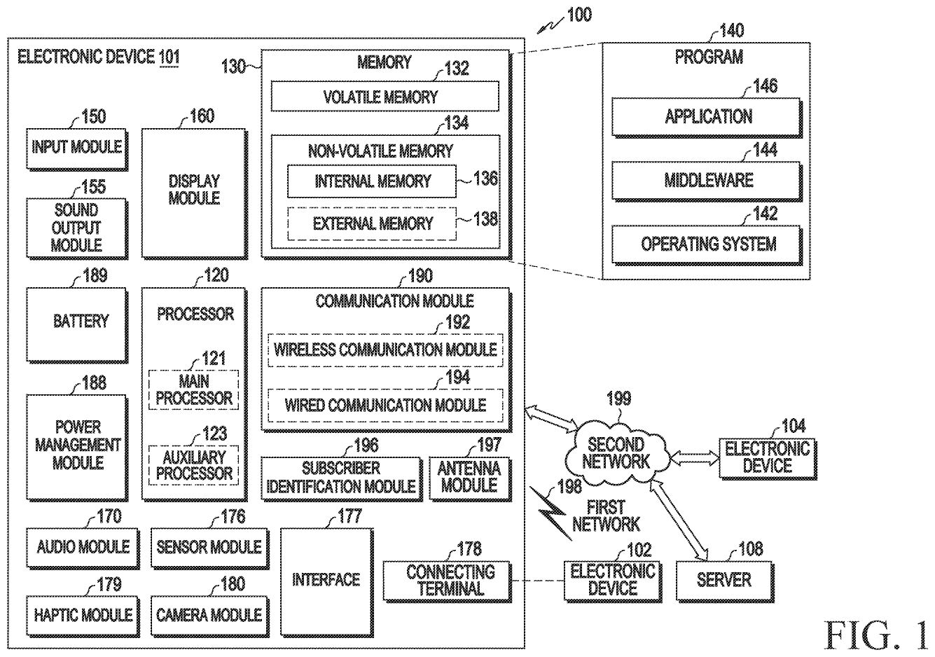

FIG. 1 is a block diagram schematically illustrating an electronic device.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™ wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

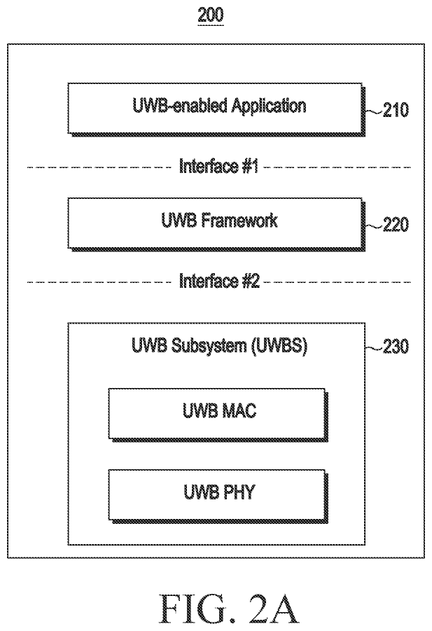

FIG. 2A illustrates an example architecture of a UWB device according to an embodiment of the disclosure.

In the disclosure, the UWB device 200 may be an electronic device (e.g., a FiRa device) supporting UWB communication. For example, the UWB device 200 may be an example of the electronic device 101 of FIG. 1.

In the embodiment of FIG. 2A, the UWB device 200 may interact with other UWB devices through a UWB session.

The UWB device 200 may implement a first interface (Interface #1) that is an interface between the UWB-enabled Application 210 and the Framework 220, and the first interface allows the UWB-enabled application 110 on the UWB device 200 to use the UWB capabilities of the UWB device 200 in a predetermined manner. In an embodiment, the first interface may be a Framework API or a proprietary interface, but is not limited thereto.

The UWB device 200 may implement a second interface (Interface #2) that is an interface between the UWB Framework 210 and the UWB subsystem (UWBS, 230). In an embodiment, the second interface may be a UWB Command Interface (UCI) or proprietary interface, but is not limited thereto.

Referring to FIG. 2A, the UWB device 200 may include a UWB-enabled Application 210, a Framework (UWB Framework) 220, and/or a UWBS 230 including a UWB MAC Layer and a UWB Physical Layer. According to an embodiment, some components of the UWB device may not be included in the UWB device, or additional components (e.g., a secure component) may be further included. Further, a plurality of components of the UWB device may be merged into a single component.

The UWB-enabled Application 210 (e.g., FiRa-enabled Application) may trigger establishment of a UWB session by a UWBS 230 through the first interface. The UWB-enabled Application 210 may use one of previously defined profiles (profile). For example, the UWB-enabled Application 210 may use one of the profiles (FiRa profiles) defined in FiRa or a custom profile. The UWB-enabled Application 210 may use the first interface to handle related events, such as service discovery, ranging notifications, and/or error conditions.

The Framework 220 may provide access to Profiles, individual-UWB configuration and/or notifications. The Framework 220 may support at least one of a function for UWB ranging and transaction execution, a function to provide an interface to the UWB-enabled Application 210 and UWBS 230, or a function to estimate the location of the UWB device 200. The Framework 220 may manage related components (e.g., secure component, OOB subsystem OOBS, or USBS 230) according to the settings of the UWB-enabled Application 210. The Framework 220 may be a set of software components. As described above, the UWB-enabled Application 210 may interface with the Framework 220 through the first interface, and the Framework 220 may interface with the UWBS 230 through the second interface.

Meanwhile, in the disclosure, the UWB-enabled Application 210 and/or Framework 220 may be implemented by an application processor (AP) (or processor). Accordingly, in the disclosure, the operation of the UWB-enabled Application 210 and/or the Framework 220 may be understood as performed by an AP (or a processor). In this disclosure, the framework may be referred to as an AP or a processor.

The UWBS 230 may be a hardware component including a UWB MAC layer (e.g., FiRa MAC) and a UWB physical layer (e.g., FiRa PHY). The UWBS 230 may perform UWB session management and may communicate with the UWBS of another UWB device. The UWBS 230 may interface with the Framework 120 through the second interface and may obtain the secure data from the Secure Component. In an embodiment, the Framework (or application processor) 220 may transmit a command to the UWBS 230 through UCI, and the UWBS 230 may transmit a response to the command to the Framework 220. The UWBS 230 may transfer a notification to the Framework 120 through the UCI.

FIG. 2B illustrates an example configuration of a framework of a UWB device according to an embodiment of the disclosure.

The UWB device of FIG. 2B may be an example of the UWB device of FIG. 2A.

Referring to FIG. 2B, the Framework 220 may include, e.g., software components, such as Profile Manager 221, OOB Connector(s) 222, Secure Service 223, UWB service 224, and/or OOB service(s) 225.

The Profile Manager 221 (e.g., FiRa Profile Manager) may manage the profile(s) (e.g., FiRa profile) available on the UWB device. Profile may be a set of parameters required to establish communication between UWB devices. For example, a profile may include a parameter indicating which OOB secure channel is used, a UWB/OOB configuration parameter, a parameter indicating whether the use of a particular secure component is mandatory, and/or a parameter related to the file structure of the ADF. Further, the profile manager 221 may abstract UWB and OOB configuration parameters from UWB-enabled application 210. The profile manager 221 may provide a method for interacting with the OOB connector 222 and routing APDUs exchanged through an OOB connection to the secure component 240.

The UWB-enabled application 210 (e.g., FiRa-enabled application) may communicate with the profile manager 221 through a first interface (e.g., Framework API).

The OOB connector 222 (e.g., FiRa OOB connector) may serve to establish and manage OOB connections with other UWB devices. The OOB connector 222 may use the OOB service 225 to communicate with the OOB subsystem 250. The UWB device may use an OOB connection to perform APDU transfers required to exchange information necessary to establish a UWB session.

The secure service 223 may perform a role of interfacing with the secure component 240. The secure component 240 may store/manage configuration parameter(s) and/or security-related key(s) for UWB security ranging.

The UWB service 224 may serve to interface with the UWBS 230. The UWB service 224 may provide access from the profile manager 321 to the UWBS 230 by implementing a second interface (e.g., UCI).

The OOB service 225 may serve to interface with the OOB subsystem 250.

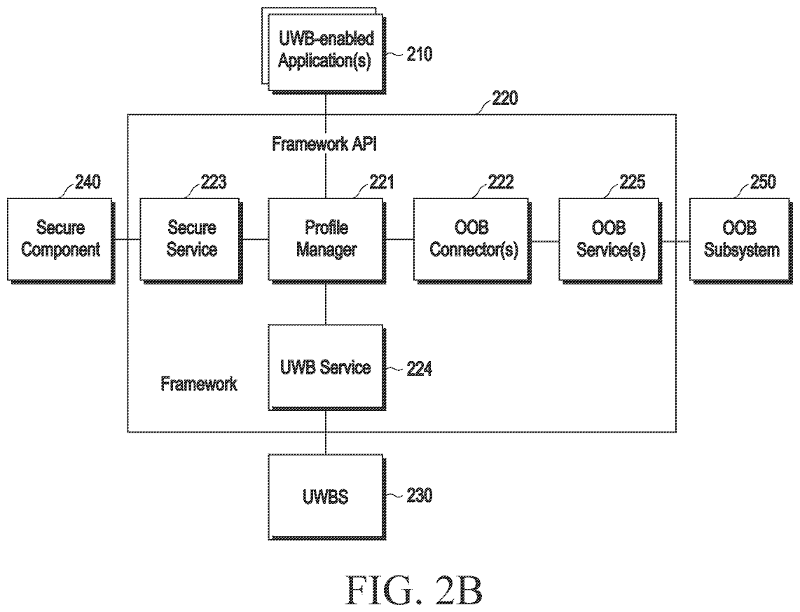

FIG. 3 is a view illustrating operations of an electronic device for issuing an UWB according to an embodiment of the disclosure.

The UWB device 300 of FIG. 3 may be an example of the UWB device of FIG. 2A or 2B. For example, the UWB device 300 may be a FiRa device.

Referring to FIG. 3, the UWB device 300 may include at least one UWB-enabled application 311, 312, and 313, a UWB framework 320, a UWBS 330, and/or a secure component 340, and for the description of the components of the UWB device 300, the description described above in FIGS. 2A and 2B may be referred to.

The UWB device 300 may include at least one UWB-enabled application provided by at least one service provider SP. For example, as illustrated, the UWB device 300 may include UWB-enabled application #1 (SP APP #1) 311, UWB-enabled application #2 (SP APP #2) 312, and UWB-enabled application #3 (SP APP #3) 313. In this case, individual UWB-enabled applications may be provided for each service provider, or a plurality of UWB-enabled applications may be provided by one service provider.

Each UWB-enabled application 311, 312, and 313 may provide a service of the corresponding UWB-enabled application. For example, UWB-enabled application #1 (SP APP #1) 311 may provide a first service (service #1), UWB-enabled application #2 (SP APP #2) 312 may provide a second service (service #2), and UWB-enabled application #3 (SP APP #3) 313 may provide a third service (service #3).

The UWB-enabled applications 311, 312, and 313 may communicate with the framework 320 (e.g., FiRa framework API) through the UWB framework API (e.g., FiRa framework API). Further, the UWB-enabled applications 311, 312, and 313 may access the UWBS 330 and secure component 340 through the framework 320. For example, the UWB-enabled applications 311, 312, and 313 may access the UWBS 330 through the profile manger 321 and UWB service 324 of the framework 320, access the secure component 340 through the profile manger 321 and secure service 323 of the framework 320, and access the OOB subsystem through the profile manager 321 and OOB service 325 of the framework 320.

The secure component 340 may be, e.g., an SE such as an eSE, and the SE may include a UWB applet 341, a SUS applet 342, and/or at least one service applet 343-1, 343-2, and 343-3. The service applet may also be referred to as an SP applet.

The UWB applet 341 (e.g., FiRa applet) may include an ADF required to securely generate an RDS, and may transfer the RDS to the UWBS 330 through the SUS applet 312.

Meanwhile, the service provider may use a separate service applet to handle the service data of the corresponding service. For example, as illustrated, the secure component 340 may include a first service applet 343-1 for service data of SP APP #1 311, a second service applet 343-2 for service data of SP APP #2 312, and a third service applet 343-3 for service data of SP APP #3 313. Each of the service applets 343-1, 343-2, and 343-3 may transfer the RDS to the UWBS 330 through the SUS applet 312 using the UWB applet 341, or may directly communicate with the SUS applet 312 using the SUS internal API.

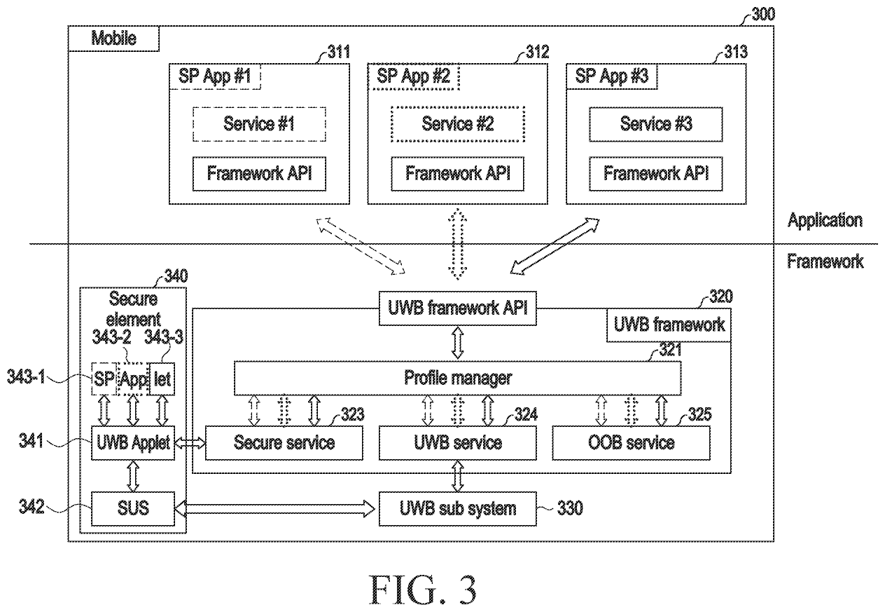

FIG. 4 illustrates a method for exchanging data between UWB devices including a secure element according to an embodiment of the disclosure.

Referring to FIG. 4, a first UWB device 4100 may include a UWB-enabled application 4110, a UWB framework 4120, a UWBS 4130, a secure component 4140 and an OOBS 4150, and a second UWB device 4200 may include a UWB-enabled application 4210, a UWB framework 4220, a UWBS 4230, a secure component 4240 and an OOBS 4250. For the descriptions of the components of each of the UWB devices 4100 and 4200, the descriptions made above with reference to FIGS. 2A, 2B, and 3 may be referred to.

The secure components 4140 and 4240 of the embodiment of FIG. 4 may be secure elements (e.g., eSE) positioned outside the frameworks 4120 and 4220.

The respective secure components 4140 and 4240 of the UWB devices 4100 and 4200 may include service apps 4143 and 4243, respectively, for storing/managing service data provided by the service provider 400. For the description of the service applets 4143 and 4243, the description of FIG. 3 may be referred to.

In the embodiment of FIG. 4, the UWB applets 4141 and 4241 (e.g., FiRa applets) of the secure components 4140 and 4240 are used to establish a secure channel and UWB session between the two UWB devices 4100 and 4200, but service data included in the service applets 4143 and 4243 may be exchanged between the two UWB devices 4100 and 4200 without the use of the UWB applets 4141 and 4241. For example, after a secure channel (e.g., OOB secure channel) and a UWB session are established between the two UWB devices 4100 and 4200 using the UWB applets 4141 and 4241, the service applets 4143 and 4243 may use a channel set to transfer service data. In an embodiment, the service applets 4143 and 4243 may use a channel set for transferring service data when a specific condition (e.g., a preset ranging condition) is met.

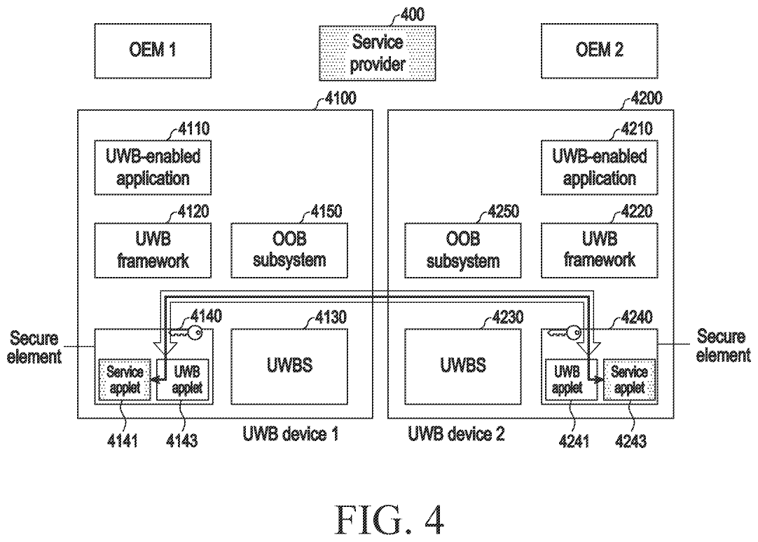

One of the two UWB devices 4100 and 4200 may operate as a service initiator. The role of the service initiator may be independent of the UWB role (e.g., UWB initiator or UWB responder). The UWB device, which is a service initiator, may use a secure channel to access the service applet of another UWB device through the tunnel interface of the UWB applets 4141 and 4241. The service applet APDU(s) wrapped with the secure channel message(s) may be transferred to the service applets 4143 and 4243 without being unwrapped in the UWB applets 4141 and 4241. Similarly, the response of the service applets 4143 and 4243 may be wrapped with a secure channel message(s) and transferred to other UWB devices. Transfer of the service applet APDU(s) through such an established secure channel may ensure that the service data transaction is associated with the UWB session. An example of a procedure for establishing a secure channel between two UWB devices 4100 and 4200 is described below with reference to FIG. 5.

FIG. 5 illustrates a method for establishing a secure channel between UWB devices according to an embodiment of the disclosure.

The UWB device should have access to the following elements in order to read and update the data of other UWB devices:
OID of the ADF including data
Tag number for the element to be read and updated
Secure messaging authentication keys required to establish a secure channel

Hereinafter, a procedure in which the UWB device establishes a secure channel and reads or updates data in the ADF of another UWB device is described with reference to FIG. 5.

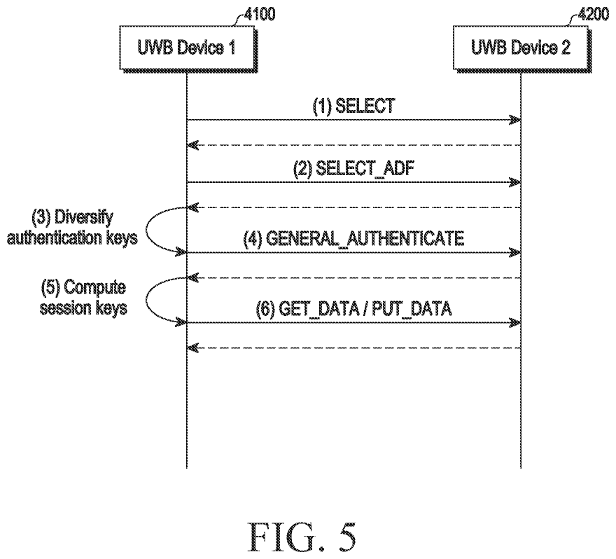

Step (1): The first UWB device 4100 may transmit a SELECT command for selecting the application data structure to the second UWB device 4200. The SELECT command may be an APDU command used by the UWB device to select an application data structure using a well-known application ID. An example of the application data structure is described below with reference to FIG. 6.

Step (2): The first UWB device 4100 may transmit a SELECT_ADF command including a list (sequence) of candidate OIDs of ADFs intended to be handled by the first UWB device 4100 to the second UWB device 4200. The SELECT_ADF command may be an APDU command used by the UWB device to select an ADF within the application data structure that the UWB device intends to read or write.

Step (3): Using privacy selection keys, the first UWB device 4100 may decrypt the response to the SELECT_ADF command in order to determine whether one of the requested OIDs is present in the second UWB device 4200. When one of the requested OIDs is present in the second UWB device 4200, the first UWB device 4100 may extract a diversifier from the response and use the diversifier to calculate or diversify secure message authentication keys.

Step 4: The first UWB device 4100 may transmit a GENERAL AUTHENTICATE command (part 1) to the second UWB device 4200 to obtain a random challenge from the second UWB device 4200. In response to the random challenge, the first UWB device 4100 may transmit a GENERAL AUTHENTICATE command (part 2) to the second UWB device 4200 using an encrypted challenge to establish a secure channel with the second UWB device 4200. The GENERAL AUTHENTICATE command may be an APDU command used by the UWB device to establish a secure channel with the selected ADF within the GDF.

Step (5): When the secure message authentication key is correct, the response (APDU response) to the GENERAL AUTHENTICATE command (part 2) may include data that allows the first UWB device 4100 to calculate secure message session keys to be used to secure transmission in a specific secure channel session with the second UWB device 4200. Subsequently, all subsequent commands may be protected using the secure message session key.

Step (6): The first UWB device 4100 may transmit a GET DATA command to read content of a specific object or a PUT_DATA command to update objects to the second UWB device 4200. The GET DATA command may be an APDU command that allows the UWB device (or UWB-enabled application) to read data. The PUT_DATA command may be an APDU command that allows the UWB device (or UWB-enabled application) to write data to the ADF.

Through the established secure channel (e.g., OOB secure channel), e.g., data and/or service data for establishing a UWB session may be exchanged between UWB devices. Data exchange through the OOB secure channel may be performed using an OOB message. The OOB message may include a CONTROLEE_INFO message for transferring the information about the controlee to the controller and/or a SESSION DATA message for transferring UWB session-related data from the controller to the controlee.

The CONTROLEE_INFO message may include a UWB_CAPABILITY data object, a UWB CONTROLEE PREFERENCE data object, a SESSION KEY INFO data object, and/or a UWB_REGULATORY data object.

The SESSION DATA message may include a UWB_CONFIGURATION data object, a SESSION_KEY_INFO data object, and/or a UWB REGULATORY data object.

FIG. 6 illustrates an example of an application data structure according to an embodiment of the disclosure.

In FIG. 6, for convenience of description, it is assumed that the application data structure includes two ADFs, but is not limited thereto. For example, the application data structure may include a single or various numbers of ADFs.

Referring to FIG. 6, data/information included in the application data structure may be structured as data object(s) that may be accessed using tag numbers. The data object DO may be implemented with open access or may be implemented to be protected by a key. When implemented to be protected by a key, valid mutual authentication needs to be performed to access DO.

In the example of FIG. 6, the application data structure may include a root-level UWB Info data object 600. The UWB Info data object 600 may include a UWB CAPABILITY data object 601 and/or a UWB_REGULATORY data object. The application data structure or GDF may be identified by the application ID.

The UWB_CAPABILITY data object 601 may be a data object that is present and is provisioned to provide the performances of the UWB device. Any settings outside of what is defined by this data object 601 may not be used to establish a UWB ranging session. The data object 601 may be set by a framework based on UWBS performance information obtained through UCI.

The UWB REGULATORY data object 602 may be a data object used by the framework to set regulatory information about the UWB device. To access this root level, the above-described SELECT command may be used.

The application data structure may include data object(s) of the ADF level. For example, as illustrated, an ADF1 data object 610 identified by OID1 and an ADF2 data object 620 identified by OID2 may be included in the application data structure.

The ADF data object 610 and 620, respectively, may include UWB controlee info data objects 611 and 621, UWB session data objects 612 and 622, and/or at least one additional data object 613 and 623.

The UWB controlee info data objects 611 and 621 may include a UWB CAPABILITY data object designating UWB performances of the UWB device and a UWB REGULATORY data object designating regulatory information. The UWB CAPABILITY data object and the UWB_REGULATORY data object included in the UWB controlee info data objects 611 and 621 may be copies of the contents of the UWB CAPABILITY data object 601 and the UWB_REGULATORY data object 602, which are root level data objects.

Furthermore, the UWB controlee info data objects 611 and 621 may further include data (e.g., dynamic STS key or static STS key material) for session encryption and UWB CONTROLEE PREFERENCE data object that designates a preferred configuration.

The UWB session data objects 612 and 622 may be data objects used by the controller to establish a UWB session. The UWB session data objects 612 and 622 may include a UWB_SESSION_ID data object, a UWB_SUB_SESSION_ID data object, a CONFIGURATION_PARAMETERS data object, a STATIC_RANGING_INFO data object, a SECURE_RANGING_INFO data object, and/or a REGULATORY INFORMATION data object.

At least one additional data object 613 and 622 may include, e.g., a service data object including service data.

Meanwhile, according to an embodiment, the service data object may not be included in the ADF included in the UWB applet (e.g., UWB applet 4143 or 4243 of FIG. 4) in the secure element, but may be configured as a separate data object. In this case, the service data object may be included in the service applet (e.g., service applets 4141 and 4241 in FIG. 4) in the secure element, in the UWB-enabled application (e.g., UWB-enabled application 4110 or 4210 in FIG. 4), or in the software-based secure component in the framework to be described below.

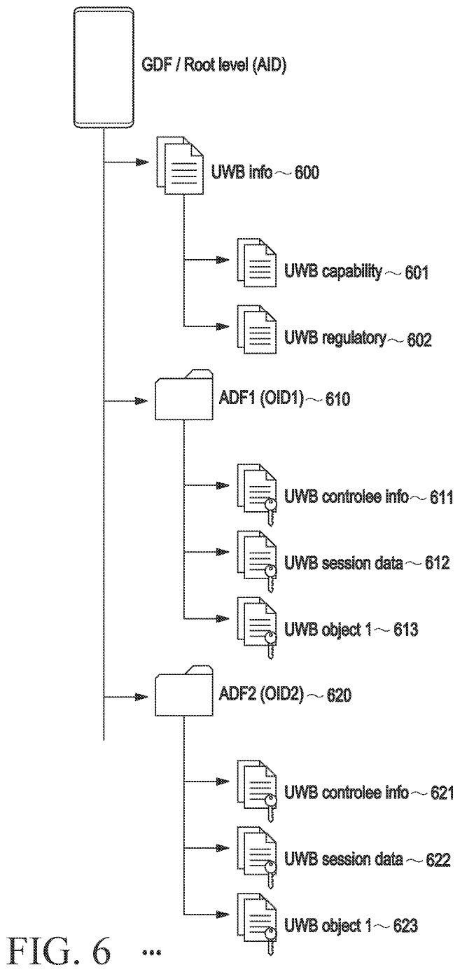

FIG. 7 illustrates a method for a UWB device to manage data using a secure element according to an embodiment of the disclosure.

Referring to FIG. 7, a UWB device 700 may include a UWB-enabled application 710, a framework 720, and/or a secure component 730. The framework 720 may include a profile manager 721, an OOB connector 722, and/or a secure service 723. For the description of the components of the UWB device 400, the description made above with reference to FIGS. 2A, 2B, 3, and 4 may be referred to.

In an embodiment of FIG. 7, the UWB device 700 includes a secure element (e.g., eSE) as the secure component 730.

In an embodiment, information related to secure components available in UWB devices may be included in connector performance information (e.g., FiRa connector capabilities information) for the OOB connector and transmitted to other UWB devices.

For example, the connector capability information may include list information (secure component list information) about at least one secure component available for OOB communication. The secure component list information may be referred to as secure component identifier (SECID) list information (list of SECIDs). The secure component list information may include, for each secure component available for OOB communication, SECID information indicating the ID (SECID) of the corresponding secure component, secure component type information indicating the type of the secure component of the corresponding secure component, and/or secure component protocol type information indicating the protocol type of the secure component.

Table 1 below shows an example of secure component information included in connector capability information.

TABLE 1

| Field name | Size (bits) | Coding explanation |
|---|---|---|
| List of SECIDs | variable | A device which is updating or exposing the FiRa |
| | (multiple of 16) | Connector Capabilities data structure should list in |
| | | this field all specific SECIDs available for OOB |
| | | communication. The administrative SECID with 7-bit |
| | | value 0b0000001 is implicit and shall not be listed |
| | | here. Each SECID consumes 16 bits coded as follows |
| | | (from the most significant bit): |
| | | 1 bit - Static indication (if given SECID is granted to |
| | | be always available it shall be set to value 0b1, |
| | | otherwise it is set to value 0b0). |
| | | 7 bits - SECID value (unsigned integer in the range |
| | | 2 . . . 127, values 0 and 1 are reserved). See FiRa |
| | | Connector Message structure definition for more |
| | | details. |
| | | 4 bits - Secure Component type (value 0 . . . 15, see |
| | | separate section for encoding rules). |
| | | 4 bits - Secure Component protocol type (value 0 . . . 15, |
| | | see separate section for encoding rules). |

Table 2 below shows an example of secure component type information.

TABLE 2

| Value | Secure Component type |
|---|---|
| 0 (0b0000) | Reserved for future use. |
| 1 (0b0001) | eSE (non-removable, as defined by [6]) |
| 2 (0b0010) | UICC (removable, as defined by [7]) |
| 3 (0b0011) | Discrete eUICC (removable, as defined by [8]) |
| 4 (0b0100) | Discrete eUICC (non-removable, as defined by [8]) |
| 5 (0b0101) | Integrated eUICC (non-removable, as defined by [8]) |
| 6 (0b0110) | SW emulated SC (e.g. Android HCE) |
| 7 . . . 14 (0b0111 . . . 0b1110) | Reserved for future use. |
| 15 (0b1111) | Vendor proprietary. |

In an embodiment, the UWB device may transmit or broadcast connector capability information or secure component list information through an OOB message (e.g., a BLE advertisement message/packet). For example, connector capability information or secure component list information may be included in the UWB identification data field of the BLE advertisement message/packet.

In an embodiment, the UWB device may transmit or broadcast connector capability information or secure component list information through a UWB message (e.g., an OWR message for advertisement).

Referring to FIG. 7, a procedure for managing data using a secure element (e.g., eSE) may include the following steps. The data may include data and service data for establishing a UWB session, and the data may be stored in the secure element. In FIG. 7, it is assumed that the secure component type information is set to a value designating the eSE.

### [Step 1]

The UWB-enabled application 710 may call a service initiation API (e.g., an FIRAServiceInit API) for initiating a corresponding service or a profile for the corresponding service of the UWB-enabled application 710. The service initiation API may be called by the UWB-enabled application of the corresponding UWB device when the UWB-enabled application is launched on the UWB device.

The FIRAServiceInit API may be used by the UWB-enabled application 710 to register the UWB-enabled application 710 in the framework 720, instantiate a specific UWB profile (FiRa profile), and request to apply a specific configuration requested by the UWB-enabled application 710. The FIRAServiceInit API may include a ServiceConfiguration object, a UWBCconfiguration object, and/or an OOBConfiguration object.

The ServiceConfiguration object may be used to instantiate a UWB profile (FiRa profile) and map it to a specific application. Table 3 below may be an example of the ServiceConfiguration object.

TABLE 3

| Parameter | Type | Description |
|---|---|---|
| serviceID | Integer | Identifier for the FiRa Profile that the FiRa- |
| | | enabled Application supports. |
| | | For FiRa Profiles, the ServiceID defined in the |
| | | corresponding FiRa Profile specification is |
| | | mandatory and the UWB Configuration and |
| | | OOB Configuration do not need to be set (as |
| | | they are specified in the FiRa Profile |
| | | specification and known to the FiRa |
| | | Framework). |
| | | For custom settings, the FiRa-enabled |
| | | Application shall set the ServiceID to 255 and |
| | | transfer UWB configuration and OOB |
| | | configuration. |
| profilePriority | Integer | Priority of the FiRa Profile instance. It is used by |
| | | the FiRa Framework to allocate resources |
| | | appropriately. |
| | | 1 = highest priority; |
| | | 100 = lowest priority |
| | | The use of the Profile priority is platform |
| | | dependent. |
| serviceDeploymentOption | Integer | Indicates the chosen deployment option |
| | | 1 = service deployment scenario 1 |
| | | 2 = service deployment scenario 2 |
| | | 3 = service deployment scenario 3 |
| | | 4 = service deployment scenario 4 |
| | | 5 = service deployment scenario 5 |
| | | . . . |
| serviceAppletID | Integer | AID of Service Applet to be used by the FiRa |
| | | Framework. |
| serviceAdfID | Integer | Tag OID of the ADF used for service |
| | | deployement |

The UWBCconfiguration object may be used to set individual UWB parameters, e.g., when a custom profile is used. Table 4 below may be an example of the UWBConfiguration.

TABLE 4

| Parameter | Type | Description |
|---|---|---|
| UWBRole | Integer | Used to indicate selected UWB roles: |
| | | 0: Controlee & Responder |
| | | 1: Controlee & Initiator |
| | | 2: Controller & Responder |
| | | 3: Controller & Initiator |
| rangingRoundUsage | Integer | 0: One way ranging (OWR). |
| | | 1: Single-Sided Two-Way Ranging (SS-TWR) with |
| | | Deferred Mode. |
| | | 2: Double-Sided Two-Way Ranging (DS-TWR) with |
| | | Deferred Mode. |
| | | 3: Single-Sided Two-Way Ranging (SS-TWR) with Non- |
| | | deferred Mode. |
| | | 4: Double-Sided Two-Way Ranging (DS-TWR) with Non- |
| | | deferred Mode |
| multiNodeMode | Integer | 0: Unicast Ranging |
| | | 1: One-to-many Ranging |
| | | 2: Many-to-many Ranging |
| RFRAMEConfiguration | Integer | 0: SP0 |
| | | 1: SP1 |
| | | 2: RFU |
| | | 3: SP3 |
| STSConfig | Integer | 0: Static STS |
| | | 1: Dynamic STS using a single UWB Session Key for all |
| | | Responders |
| | | 2: Dynamic STS using Responder Specific Sub-session Key |
| roundHopping | Boolean | 0: Round Hopping disabled |
| | | 1: Round Hopping enabled |
| scheduledMode | Integer | 0: Contention Based Ranging |
| | | 1: Time Scheduled Ranging |
| maximumContentionPhaseLength | Integer | Maximum number of slots for Contention-Based ranging |
| ToFReport | Boolean | 0: No ToF Report |
| | | 1: ToF Report |
| AoAAzimuthReport | Boolean | 0: No AoA Azimuth Report |
| | | 1: AoA Azimuth Report |
| AoAElevationReport | Boolean | 0: No AoA Elevation Report |
| | | 1: AoA Elevation Report |
| AoAFOMReport | Boolean | 0: No AoA FOM Report |
| | | 1: AoA FOM Report |
| blockStriding | Boolean | 0: No Block Striding |
| | | 1: Blocks may be skipped upon Controller's decision |
| slotDuration | Integer | Unsigned integer that specifies the duration of a ranging slot |
| | | in the unit of RSTU |
| slotsPerRangingRound | Integer | Number of slots per ranging round. This parameter is not |
| | | applicable for contention based ranging. This parameter is |
| | | used to specify the ranging round duration in multiples of |
| | | SlotDuration |
| rangingInterval | Integer | Unsigned integer that specifies the duration of a ranging |
| | | block. Expressed in the unit of 1200 RSTU which is 1 ms |
| | | between beginning of one ranging round to the beginning of |
| | | the next. Minimum ranging interval should be at least the |
| | | duration of one ranging round length. |
| channelNumber | Integer | Unsigned integer that specifies channel number to be used. |
| | | Allowed values include: |
| | | [5, 6, 8, 9, 10, 12, 13, 14] |
| preambleCodeIndex | Integer | Ci Code index |
| | | Value range: 9-12 for BPRF Mode |
| | | Value range: 25-32 for HPRF Mode |
| SP0PHYParameterSet | Integer | SP0 PHY parameter set# according to Table 2 or Table 3 of |
| | | FiRa Consortium UWB PHY Technical Requirements (see |
| | | Appendix E for supported set pairs) |
| SP1PHYParameterSet | Integer | SP1 PHY parameter set# according to Table 2 or Table 3 of |
| | | FiRa Consortium UWB PHY Technical Requirements (see |
| | | Appendix E for supported set pairs) |
| SP3PHYParameterSet | Integer | SP3 PHY parameter set# according to Table 2 or Table 3 of |
| | | FiRa Consortium UWB PHY Technical Requirements (see |
| | | Appendix E for supported set pairs) |
| maxRetry | Integer | Unsigned integer that specifies the number of failed ranging |
| | | rounds before timing out. Note: The number of retries must |
| | | be chosen so that the total retry time does not exceed 10 s |
| | | due to FCC rules. |
| constraintLengthConvolutionalCode | Boolean | 0: K = 3 (Systematic convolutional encoding), 1: K = 7 (Non- |
| | | systematic convolutional encoding) |
| | | Note: For BPRF mode, systematic convolutional encoding |
| | | shall be used. |
| UWBInitiationTime | Integer | Time taken for UWB initiation (in the unit of 1200 RSTU) |
| | | Controller shall transmit UWB frames after UWB initiation |
| | | time from transmitting timing of this parameter |
| | | Controller should set UWB initiation time in consideration |
| | | of UWB initiation time of Controlee |
| keyRotationRate | Integer | Defines n, with 2\hat{ }n being the rotation rate of |
| | | secDerivedPayloadKey, secDerivedAuthenticationIv, and |
| | | secDerivedAuthenticationKey. If this parameter has value |
| | | 0x3F, then no key rotation will be applied. |
| MACFCSType | Enum | 0: 2 octets CRC will be used for FCS in MAC footer |
| | | 1: 4 Octets CRC will be used for FCS in MAC footer |
| | | Note: For BPRF mode, 2 octets CRC is used. |
| RangingRoundControl | Integer | This parameter is used to tell the UWBS which messages |
| | | will be included in a Ranging Round. The parameter is a bit |
| | | map with the following definition: |
| | | b0 = Ranging Result Report Message (RRRM) |
| | | If set to 1 (default), an initiator shall schedule an RRRM in |
| | | the Ranging Device Management List (RDML). |
| | | If set to 0, an initiator shall not schedule an RRRM in the |
| | | RDML |
| | | This bit shall be ignored by a responder; responders shall |
| | | follow the message sequence provided in the RDML. |
| | | b1 = Control Message (CM) |
| | | If set to 1 (default), an initiator shall send a separate CM and |
| | | a responder shall expect a separate CM |
| | | If set to 0, an initiator shall not send a separate CM and a |
| | | responder shall not expect a separate CM |
| | | b6 to b2 = RFU |
| | | b7 = Measurement Report Message (MRM) |
| | | If set to 0 (default), the controller shall schedule the MRM |
| | | to be sent from the initiator to the controlee(s) in the RDML. |
| | | If set to 1, the controller shall schedule the MRM to be sent |
| | | from the responder(s) to the initiator in the RDML. |
| | | This bit shall be ignored by a Controlee. Controlees shall |
| | | follow the message sequence provided in the RDML. |
| vendorID | Integer | 16 bits unsigned integer, Unique ID of vendor. Vendor in |
| | | this context is the FiRa enabled application provider. This is |
| | | used to set phy Vupper64[15:0] as defined in FiRa MAC |
| | | technical requirements |
| staticSTSIV | ByteArray[6] | Array of 6 bytes. Pre-defined arbitrary value chosen by the |
| | | vendor for FiRa enabled application on FiRa Smart Device |
| | | and FiRa device. This is used to set vUpper64[63:16] as |
| | | defined in FiRa MAC technical requirements. |

The OOBConfiguration object may be used to set individual OOB parameters, e.g., when a custom profile is used. Table 5 below may be an example of an OOBConfiguration object.

TABLE 5

| Parameters | Type | Description |
|---|---|---|
| OOBType | Integer | This indicates the type of OOB connection used for FiRa |
| | | Service establishment |
| | | None - value ‘0’ |
| | | Bluetooth LE - value ‘1’ |
| | | RFU - all other values |
| OOBBLERole | Integer | This indicates the role of FiRa Device for OOB GAP and |
| | | GATT |
| | | Scanner/Central & GATT Client (CP) Value 0 |
| | | Advertiser/Peripheral & GATT Server (FCS) Value 1 |
| | | Peripheral Value 2 |
| | | Central. Value 3 |

The UWB-enabled application 710 may transfer the above-described FIRAServiceInit parameters, e.g., parameters included in the ServiceConfiguration object, the UWBCconfiguration object, and/or the OOBConfiguration object, to the framework 720, using the FIRAServiceInit API. For example, as illustrated, serviceDeploymentOption parameter values (e.g., serviceDeploymentOption=1), the parameter of serviceAppletID (e.g., serviceAppletID=<0xA00000086746415000>) may be transferred through the FIRAServiceInit API. The value of the serviceDeploymentOption parameter and the value of the serviceAppletID parameter may be included in the ServiceConfiguration object.

### [Step 2]

The framework 720 may transfer a return value for the FIRAServiceInit to the UWB-enabled application 710. In an embodiment, the return value may include a value of the serviceInstanceID parameter or a value of the statusCode parameter. The serviceInstanceID parameter may be a service instance ID for a corresponding service or profile of 128 bits allocated by the profile manager 721.

### [Step 3]

The UWB device 700 may establish a secure channel with another UWB device. The procedure for establishing a secure channel between UWB devices may follow the procedure for establishing a secure channel of FIG. 5. Through the established secure channel, the UWB controlee info data object, the UWB session data object, and/or the service data object may be exchanged between the FiRa applets and/or the service applets in the secure components (e.g., eSE) of the two UWB devices. The service applet may be identified by the value of the serviceAppletID parameter in the above-described ServiceConfiguration object.

The above-described data management method according to the embodiment of FIG. 7 uses a hardware-based secure component (e.g., eSE) outside the framework. However, according to an embodiment, the UWB device may not include a separate hardware-based secure component positioned outside the framework. In this case, software-based secure components for storing/managing data and/or service data for establishing a UWB session in the framework need to be assigned to the framework.

Hereinafter, a data management method using a software-based secure component allocated in a framework is described.

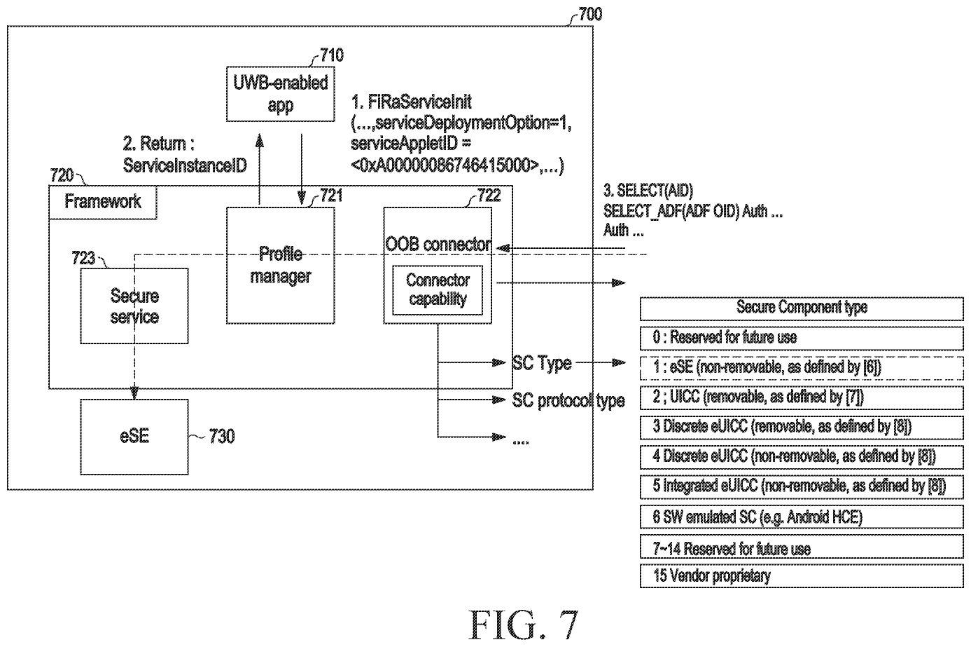

FIG. 8 illustrates a method for a UWB device to manage data using a secure component in a framework according to an embodiment of the disclosure.

Referring to FIG. 8, a UWB device 800 may include a UWB-enabled application 810, a framework 820, and/or a secure component 830. The framework 820 may include a profile manager 821, an OOB connector 822, and/or a secure service 823. For the description of the components of the UWB device 400, the description made above with reference to FIGS. 2A, 2B, 3, and 4 may be referred to.

In the embodiment of FIG. 8, the UWB device 800 includes a software (SW)-based secure component (e.g., SW emulated SC) 830, as a secure component, in the framework 820.

In an embodiment, information related to the secure components available in the UWB device may be included in connector capability information (e.g., FiRa connector capabilities information) for the OOB connector 822, and transmitted to other UWB devices.

For example, the connector capability information may include list information (secure component list information) about at least one secure component available for OOB communication. The secure component list information may be referred to as SECID list information (list of SECIDs). The secure component list information may include, for each secure component available for OOB communication, SECID information indicating the ID (secure component identifier (SECID)) of the corresponding secure component, secure component type information indicating the type of the secure component of the corresponding secure component, and/or secure component protocol type information indicating the protocol type of the secure component.

An example of the secure component information included in the connector capability information may be as illustrated in Table 1.

An example of the secure component type information including the type of the software (SW)-based secure component may be shown in Table 6 below.

TABLE 6

| Value | Secure Component type |
|---|---|
| 0 (0b0000) | Reserved for future use. |
| 1 (0b0001) | eSE (non-removable, as defined by [6]) |
| 2 (0b0010) | UICC (removable, as defined by [7]) |
| 3 (0b0011) | Discrete eUICC (removable, as defined by [8]) |
| 4 (0b0100) | Discrete eUICC (non-removable, as defined by [8]) |
| 5 (0b0101) | Integrated eUICC (non-removable, as defined by [8]) |
| 6 (0b0110) | SW emulated SC in TEE (e.g. Android HCE) |
| 7 (0b0111) | SW emulated SC in Framework |
| 8 . . . 14 (0b1000 . . . 0b1110) | Reserved for future use. |
| 15 (0b1111) | Vendor proprietary. |

In an embodiment, the UWB device may transmit or broadcast connector capability information or secure component list information through an OOB message (e.g., a BLE advertisement message/packet). For example, connector capability information or secure component list information may be included in the UWB identification data field of the BLE advertisement message/packet.

Referring to FIG. 8, a procedure for managing data using a software-based secure component in a framework may include the following steps. The data may include data and service data for establishing a UWB session, and the data is stored in the secure element. In FIG. 8, it is assumed that the secure component type information is set to a value designating “SW emulated SC in framework”.

### [Step 1]

The UWB-enabled application 810 may call a service initiation API (e.g., an FIRAServiceInit API) for initiating a corresponding service or a profile for the corresponding service of the UWB-enabled application 810. The service initiation API may be called by the UWB-enabled application of the corresponding UWB device when the UWB-enabled application is launched on the UWB device.

The FIRAServiceInit API may be used by the UWB-enabled application 810 to register the UWB-enabled application 810 in the framework 820, instantiate a specific UWB profile (FiRa profile), and request to apply a specific configuration requested by the UWB-enabled application 810. The FIRAServiceInit API may include a ServiceConfiguration object, a UWBCconfiguration object, and/or an OOBConfiguration.

The ServiceConfiguration object may be used to instantiate a UWB profile (FiRa profile) and map it to a specific application. The ServiceConfiguration object may include some or all of the parameters included in Table 3. According to an embodiment, the ServiceConfiguration object may further include a servicePackagename parameter. The servicePackagename parameter may be set to a value (e.g., android package name) of the application ID of the UWB-enabled application 810.

The UWBCconfiguration object may be used to set individual UWB parameters, e.g., when a custom profile is used. The UWBConfiguration object may include some or all of the parameters included in Table 4.

The OOBConfiguration object may be used to set individual OOB parameters, e.g., when a custom profile is used. The OOBConfiguration object may include some or all of the parameters included in Table 5.

The UWB-enabled application 810 may transfer the above-described FIRAServiceInit parameters, e.g., parameters included in the ServiceConfiguration object, the UWBCconfiguration object, and/or the OOBConfiguration object, to the framework 820, using the FIRAServiceInit API. For example, as illustrated, through the FIRAServiceInit API, serviceDeploymentOption parameter value (e.g., serviceDeploymentOption=5), serviceAppletID parameter (e.g., serviceAppletID=<0xA00000086746415000>) value, serviceAdfID parameter value (e.g., a value indicating that the serviceAdfID is not used (e.g., serviceADFID=<no use>), and/or servicePackagename parameter value (e.g., a value set by the UWB-enabled Application 810) may be transferred to the framework 820.

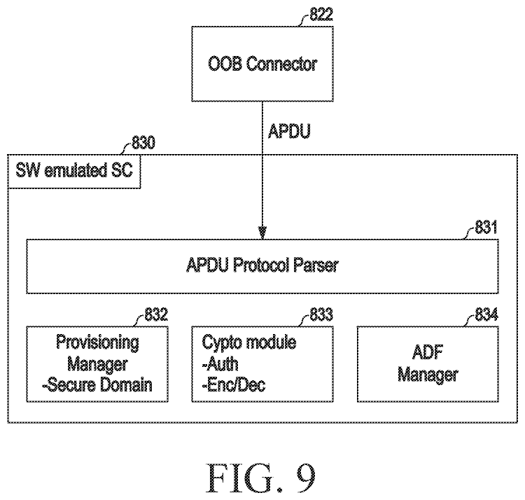

In an embodiment, when the serviceAdfID parameter value in the ServiceConfiguration object is set to a value (e.g., serviceAFDID=<no use>) indicating that the serviceAdfID parameter is not used, or the serviceAdfID parameter in the ServiceConfiguration object is not included, the framework 820 or the profile manager 821 in the framework 820 may use a value generated using the value of the vendorID parameter in the UWBConfiguration object and the value of the serviceID parameter in the ServiceConfiguration object, as the value of the serviceInstanceID parameter. An example of generating a serviceInstanceID parameter is described below with reference to FIG. 10.

### [Step 2]

The framework 820 may transfer a return value for the FIRAServiceInit to the UWB-enabled application 810. In an embodiment, the return value may include a value of the serviceInstanceID parameter or a value of the statusCode parameter. The serviceInstanceID parameter may be a service instance ID for a corresponding service or profile of 128 bits allocated by the profile manager 821.

### [Step 3]

The UWB-enabled application 810 may call a provisioning API (e.g., a DoProvisioning API). The provisioning API may be used by the UWB-enabled application 810 for ADF generation and provisioning by the framework.

The provisioning API may include a serviceInstanceID parameter and/or an adfKey parameter. In provisioning, the adfKey parameter may be used as a secure channel key (SCKey).

When the provisioning API is called by the UWB-enabled application 810, the framework 820 may generate an ADF in the software-based secure component in the framework 830 and create values of parameters of the ServiceConfiguration object, UWBConfiguration object, and/or OOBConfiguration object for a profile (or service) corresponding to the value of the serviceInstanceID parameter in the ADF. Further, the framework 820 may create a key necessary to generate a secure channel with a customer device secure component (e.g., a software-based secure component in the framework of another UWB device) in another UWB device in the ADF included in the software-based secure component in the framework 830. The key (security key) required to generate a secure channel may be an adf key (ADF specific key) designated by the adfKey parameter.

Meanwhile, in the case of the embodiment of FIG. 7 using the eSE, since the provisioning authority (PA) managing the eSE or the SP authenticated by the PA generates the ADF, a fixed value agreed in advance may be used as the ADF ID. However, in the case of the embodiment of FIG. 8, it is difficult for the ADF ID to be agreed in advance with the UWB-enabled application 810 because the framework generates ADF. Therefore, in this case, instead of using the value of the ADF ID designated by the UWB-enabled application 810, the value of the ADF ID generated in the framework is used to identify the ADF.

In an embodiment, the framework 820 or the profile manager 821 of the framework may generate an ADF ID according to a preset rule.

For example, the framework 820 or profile manager 821 of the framework may use the value of the ServieInstance ID generated using the value of the serviceID parameter in the ServiceConfiguration object and the value of the vendorID parameter in the UWBConfiguration object, as the value of the ADF ID. For example, the framework 820 or the profile manager 821 of the framework may use the output obtained by performing hash code generation using, as an input, a combination of the value of the vendorID parameter in the UWBConfiguration object and the value of the serviceID parameter in the ServiceConfiguration object, as the ADF ID value. In an embodiment, a hash function (e.g., a one way hash function) for hash code generation may be, e.g., MD5, SHA256, or the like. An example of service instance ID generation and ADF ID generation is described below with reference to FIG. 10.

For example, the framework 820 or the profile manager 821 of the framework may use the value generated using the value of the servicePackagename parameter set by the UWB-enabled application 810 as the value of the ADF ID. For example, the framework 820 or the profile manager 821 of the framework may use the output obtained by performing hash code generation using, as an input, the value of the servicePackagename parameter set by the UWB-enabled application 810, as the value of the ADF ID. In an embodiment, a hash function (e.g., a one way hash function) for hash code generation may be, e.g., MD5, SHA256, or the like.

### [Step 4]

The UWB device 800 may establish a secure channel with another UWB device. The procedure for establishing a secure channel between UWB devices may follow the procedure for establishing a secure channel of FIG. 5. Through the established secure channel, the UWB controlee info data object, the UWB session data object, and/or the service data object may be exchanged between the software-based secure components in the frameworks of the two UWB devices.

Meanwhile, according to an embodiment, the service data object may not be included in the software-based secure component 830 in the framework, but may be included in the UWB-enabled application 810.

When following the above-described method of the embodiment of FIG. 8, ranging is possible even in a non-secure element environment/condition.

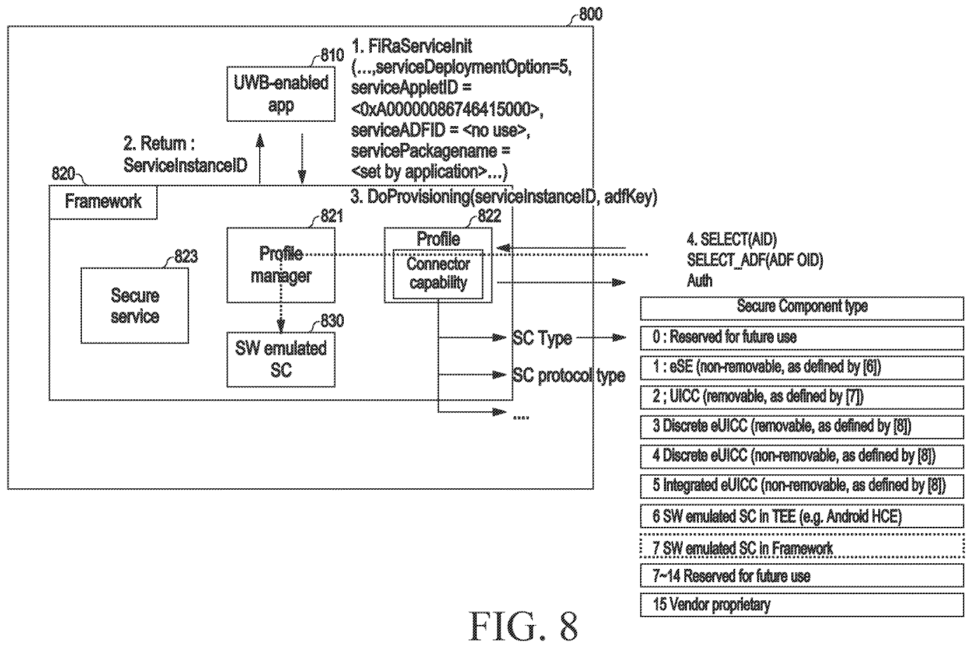

FIG. 9 illustrates a configuration of a software-based secure component according to an embodiment of the disclosure.

Referring to FIG. 9, a software-based secure component (e.g., SW emulated SC) 830 may include an APDU protocol parser 831, a provisioning manager 832, an encryption module (cypto module) 833, and/or an ADF manager 834. In an embodiment, when the value of the serviceDeploymentOption parameter is set to ‘serviceDeploymentOption=5’, and the value of the secure component type information/parameter is set to a value indicating ‘SW emulated SC in framework’, the software-based secure component 830 may be used as a secure component.

The APDU protocol parser 831 may be a component that parses an APDU (ADPU command or APDU response) transferred through the OOB connector 822 to obtain data/information included in the APDU.

The provisioning manager 832 may be a component that manages provisioning data to other UWB devices. For example, the provisioned data may be data related to the ADF generated by the framework. The provisioning manager 832 may create a secure domain in the framework or a software-based secure component (SW emulated SC) in the framework by performing the role of generating and provisioning the ADF.

The encryption module 833 may be a component that performs authentication and/or encryption/decryption for data/messages.

The ADF manager 834 may be a component that manages the ADF generated by the framework.

The application data structure (or GDF) stored in the software-based secure component 830 may have the same structure as illustrated in FIG. 6. In this case, the application ID (AID) for the application data structure may be the same as the application ID for the application data structure stored in the secure component (e.g., eSE) 730 of FIG. 7.

Meanwhile, in the case of the embodiment of FIG. 7 using eSE 730, since the provisioning authority (PA) managing the eSE or SP authenticated by the PA generates an ADF, a fixed value agreed in advance may be used as an ADF ID. However, in the case of the embodiment of FIG. 8 using the software-based secure component 830, the ADF ID is difficult to agree in advance with UWB-enabled application 810 because the framework generates the ADF. Therefore, in this case, instead of using the value of the ADF ID designated in the UWB-enabled application 810, the value of the ADF ID generated in the framework is used.

In an embodiment, the framework or the profile manager of the framework may generate an ADF ID according to a preset rule.

For example, the framework or profile manager of the framework may use the value of the ServieInstance ID generated using the value of the serviceID parameter in the ServiceConfiguration object and the value of the vendorID parameter in the UWBConfiguration object, as the value of the ADF ID.

For example, the framework or the profile manager of the framework may use the value generated using the value of the servicePackagename parameter set by the UWB-enabled application 810 as the value of the ADF ID.

FIG. 10 illustrates a method for generating a service instance ID according to an embodiment of the disclosure.

The method of generating the service instance ID of FIG. 10 may be applied, e.g., when the software-based secure component 830 of FIG. 7 or 8 is used as a secure component, but the disclosure is not limited thereto.

Referring to FIG. 10, the framework (e.g., the framework 820 of FIG. 8) or the profile manager (e.g., the profile manager 821 of FIG. 8) in the framework may generate the value of the serviceInstanceID parameter using the value of the serviceID parameter in the ServiceConfiguration object (e.g., the ServiceConfiguration object of Table 3) and the value of the vendorID parameter in the UWBConfiguration object (e.g., the UWBConfiguration object of Table 4).

In an embodiment, the procedure in which the framework or profile manager generates the value of the serviceInstanceID parameter and allocates it as an ID (ADF ID) of the ADF may include the following operations.

Operation 1: When the UWB-enabled application (e.g., the UWB-enabled application 810 of FIG. 8) calls the service initiation API (e.g., the FIRAServiceInit API), the framework or profile manager may perform a hash code generation operation using, as a message (input) 1010, a value in which the value of the vendorID parameter in the UWBConfiguration object and the value of the serviceID parameter in the ServiceConfiguration object are combined. In an embodiment, a hash function (e.g., a one way hash function) for hash code generation may be, e.g., MD5, SHA256, or the like.

Operation 2: The framework or profile manager may set the size of the digest (output) 1020 of the hash code generation to suit the size (e.g., 128 bits) of the serviceInstanceID parameter, and set the digest (output) 1020 having the size as the value of the serviceInstanceID parameter.

Operation 3: The framework or profile manager may set the value of the generated serviceInstanceID parameter as an ADF ID that designates a data storage area in the software-based secure component in the framework allocated to the corresponding UWB-enabled application. For example, ServiceInstanceID #1 1021 generated using vendorID #1/serviceID 1011 associated with the UWB-enabled application #1 may be set as an OID 1031 identifying ADF1 for the corresponding UWB-enabled application #1.

On the other hand, the counterpart UWB device may also generate the value of the serviceInstanceID parameter with the same logic as described above, and set it as an ADF ID that designates a data storage area in the software-based secure component in the framework allocated to the corresponding UWB-enabled application.

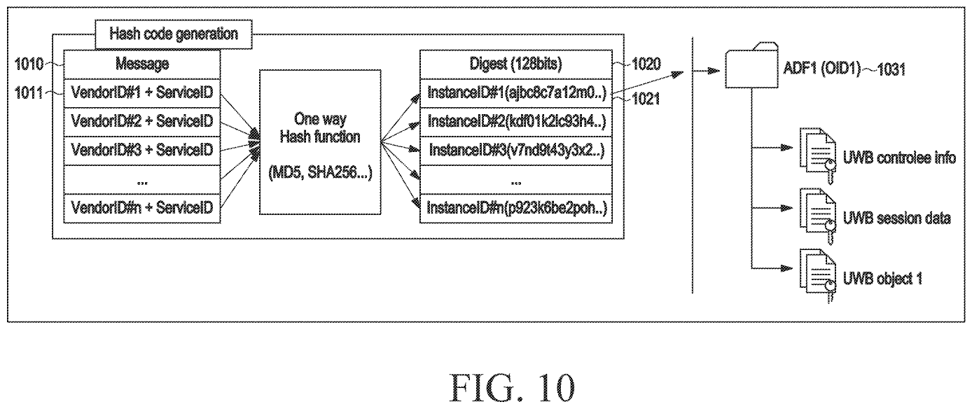

FIG. 11 illustrates a method for a UWB device to manage a UWB session according to an embodiment of the disclosure.

Referring to FIG. 11, a UWB device may identify configuration information for a service of a UWB-enabled application (1110).

The UWB device may generate service instance ID information about the service based on the configuration information (1120).

The UWB device may establish a secure channel between a software-based secure component in a framework and a software-based secure component in a framework of another UWB device (1130).

The UWB device may exchange data for establishing a UWB session between the secure components through the secure channel (1140).

In an embodiment, the configuration information may include at least one of service configuration information (e.g., ServiceConfiguration object), UWB configuration information (e.g., UWBConfiguration object), or OOB configuration information (e.g., OOBConfiguration object).

In an embodiment, the UWB device may control the UWB-enabled application to transfer the configuration information for the service to the framework of the electronic device using a framework API, and control the framework of the electronic device to transfer the generated service instance ID information to the UWB-enabled application of the electronic device.

In an embodiment, the UWB device may transmit an advertisement message including secure component type information indicating a type of a secure component to the other electronic device. The secure component information may be set to a value indicating that the type of the secure component is a software-based secure component in the framework.

In an embodiment, the UWB device may control the framework to generate the service instance ID based on a value of vendor ID information included in the UWB configuration information and a value of service ID information included in the service configuration information. The service ID information may include identification information about a profile supported by the UWB-enabled application.

In an embodiment, the service instance ID may correspond to an output obtained by performing generation of a hash code using a value in which the value of the service ID information and the value of the vendor ID information are combined, as an input.

In an embodiment, application dedicated file (ADF) ID information for identifying an ADF for the UWB-enabled application, stored in the software-based secure component in the framework of the electronic device may be set to the same value as the service instance ID information. The ADF may include data for establishing the UWB session. In an embodiment, the ADF may further include service data defined by a service provider providing the UWB-enabled application.

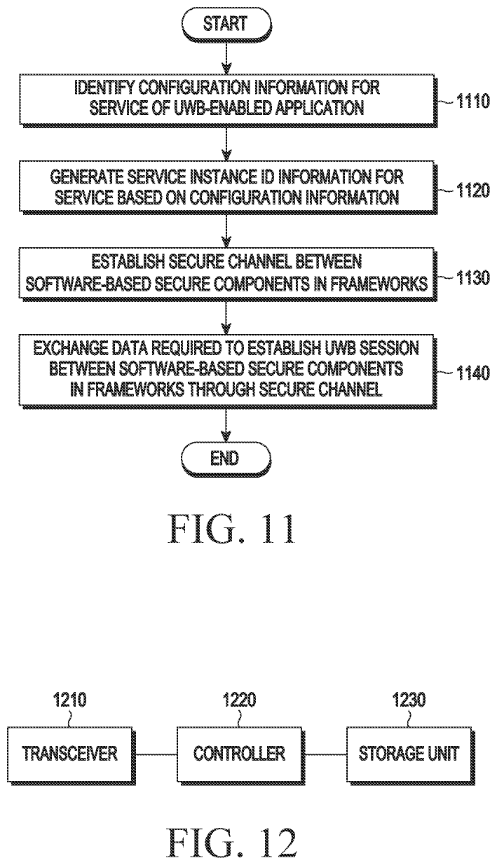

FIG. 12 illustrates a configuration of a UWB device according to an embodiment of the disclosure.

FIG. 12 is a view illustrating a structure of a UWB device according to an embodiment of the disclosure.

Referring to FIG. 12, the electronic device may include a transceiver 1210, a controller 1220, and a storage unit 1230. In the present disclosure, the controller may be defined as a circuit, an application-specific integrated circuit, or at least one processor.

The transceiver 1210 may transmit and receive signals to/from another entity. The transceiver 1210 may transmit/receive data for UWB ranging.

The controller 1220 may control the overall operation of the electronic device according to an embodiment. For example, the controller 1320 may control inter-block signal flow to perform the operations according to the above-described flowchart. Specifically, the controller 1220 may control the operations of the UWB device described above with reference to FIGS. 1, 2A, 2B, and 3 to 11.

The storage unit 1230 may store at least one of information transmitted/received via the transceiver 1210 and information generated via the controller 1220. For example, the storage unit 1230 may store information and/or service data necessary for setting up a UWB session described above with reference to FIGS. 1, 2A, 2B, and 3 to 11.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1-14. (canceled)

15. A method by an electronic device performing UWB communication, the method comprising:
identifying configuration information for a service of a UWB-enabled application;
generating service instance ID information about the service based on the configuration information;
establishing a secure channel between a software-based secure component in a framework of the electronic device and a software-based secure component in a framework of another electronic device; and
exchanging data for establishing a UWB session between the secure components through the secure channel,
wherein the configuration information includes at least one of service configuration information, UWB configuration information, or OOB configuration information.

16. The method of claim 15, further comprising:
transferring the configuration information for the service to the framework of the electronic device using a framework API by a UWB-enabled application of the electronic device; and
transferring the generated service instance ID information to the UWB-enabled application of the electronic device by the framework of the electronic device.

17. The method of claim 15, further comprising:
transmitting an advertisement message including secure component type information indicating a type of a secure component to the other electronic device,
wherein the secure component information is set to a value indicating that the type of the secure component is a software-based secure component in the framework.

18. The method of claim 15,
wherein generating the service instance ID information includes generating the service instance ID based on a value of vendor ID information included in the UWB configuration information and a value of service ID information included in the service configuration information, by the framework of the electronic device, and
wherein the service ID information includes identification information about a profile supported by the UWB-enabled application.

19. The method of claim 18, wherein the service instance ID corresponds to an output obtained by performing generation of a hash code using a value in which the value of the service ID information and the value of the vendor ID information are combined, as an input.

20. The method of claim 19,
wherein application dedicated file (ADF) ID information for identifying an ADF for the UWB-enabled application, stored in the software-based secure component in the framework of the electronic device is set to the same value as the service instance ID information, and
wherein the ADF includes data for establishing the UWB session.

21. The method of claim 20, wherein the ADF further includes service data defined by a service provider providing the UWB-enabled application.

22. An electronic device performing UWB communication, the electronic device comprising:
memory, comprising one or more storage media, storing instructions; and
one or more processors communicatively connected to the memory,
wherein the instructions, when executed by the one or more processors individually or collectively, cause the electronic device to:
identify configuration information for a service of a UWB-enabled application,
generate service instance ID information about the service based on the configuration information,
establish a secure channel between a software-based secure component in a framework of the electronic device and a software-based secure component in a framework of another electronic device, and
exchange data for establishing a UWB session between the secure components through the secure channel, and
wherein the configuration information includes at least one of service configuration information, UWB configuration information, or OOB configuration information.

23. The electronic device of claim 22, wherein the instructions that, when executed by the one or more processors individually or collectively, further cause the electronic device to:
transfer the configuration information for the service to the framework of the electronic device using a framework API by a UWB-enabled application of the electronic device, and
transfer the generated service instance ID information to the UWB-enabled application of the electronic device by the framework of the electronic device.

24. The electronic device of claim 22,
wherein the instructions that, when executed by the one or more processors individually or collectively, further cause the electronic device to transmit an advertisement message including secure component type information indicating a type of a secure component to the other electronic device, and
wherein the secure component information is set to a value indicating that the type of the secure component is a software-based secure component in the framework.

25. The electronic device of claim 22,
wherein the instructions that, when executed by the one or more processors individually or collectively, further cause the electronic device to generate the service instance ID based on a value of vendor ID information included in the UWB configuration information and a value of service ID information included in the service configuration information, by the framework of the electronic device, and
wherein the service ID information includes identification information about a profile supported by the UWB-enabled application.

26. The electronic device of claim 25, wherein the service instance ID corresponds to an output obtained by performing generation of a hash code using a value in which the value of the service ID information and the value of the vendor ID information are combined, as an input.

27. The electronic device of claim 26,
wherein application dedicated file (ADF) ID information for identifying an ADF for the UWB-enabled application, stored in the software-based secure component in the framework of the electronic device is set to the same value as the service instance ID information, and
wherein the ADF includes data for establishing the UWB session.

28. The electronic device of claim 27, wherein the ADF further includes service data defined by a service provider providing the UWB-enabled application.
